(19) United States
(12) Patent Application Publication
(10) Pub. No.: US 2026/0014602 A1
(43) Pub. Date: Jan. 15, 2026

(54) Cleaning Device and Method of Cleaning Tank

(71) Applicant: VALQUA, LTD., Tokyo (JP)

(72) Inventors: Chi Hsing Fu, Kaohsiung (TW); Chun Cheng Chen, Kaohsiung (TW)

(21) Appl. No.: 18/995,196

(22) PCT Filed: May 19, 2023
(86) PCT No.: PCT/JP2023/018770

§ 371 Date: Jan. 16, 2025

(30) Foreign Application Priority Data
Jul. 29, 2022 (JP) 2022-121124

(51) Int. Cl. B08B 9/20

(52) U.S. Cl. CPC B08B 9/20; B08B 2209/08

(57) ABSTRACT

Provided are a cleaning device and a method of cleaning a tank. Disclosed is a cleaning device configured to clean an inside of a cylindrical tank through rotation of a mounting member formed of a frame having a housing space, the mounting member fixing the tank in a state of being turned sideways in the housing space, the cleaning device including: a first rotation jig mounted on a first side portion of the mounting member; and a second rotation jig mounted on a second side portion of the mounting member, in which the first rotation jig and the second rotation jig are configured to rotate the mounting member in cooperation with each other.

### CROSS-REFERENCE TO RELATED APPLICATIONS

This application is the United States national phase of International Patent Application No. PCT/JP2023/018770 filed May 19, 2023, and claims priority to Japanese Patent Application No. 2022-121124 filed Jul. 29, 2022, the disclosures of which are hereby incorporated by reference in their entireties.

### BACKGROUND OF THE INVENTION

### Field of the Invention

The present invention relates to a cleaning device, particularly to a cleaning device used for cleaning a tank, and a method of cleaning the tank using the cleaning device.

### Description of Related Art

In a general semiconductor process, it is always necessary to use a large amount of chemical solution. In order to suppress residual impurities on a semiconductor device, purity of a chemical solution is extremely important.

Conventionally, chemical solution has been manufactured in a chemical plant and then carried to a semiconductor plant after being injected into a tank, or injected into a tank installed in the semiconductor plant, and work regarding a semiconductor process has been performed in the semiconductor plant. Therefore, it is necessary to first clean the tank in order to ensure that no impurities remain in the tank before injecting the chemical solution into the tank. As a result, impurities are not mixed into the chemical solution, and the purity of the chemical solution is kept.

### SUMMARY OF THE INVENTION

### Technical Problem

However, in a conventional method of cleaning a tank, the tank is first erected, and the inside of the tank is cleaned by spraying cleaning fluid. In the method of cleaning a tank, not only the inside of the tank cannot be cleaned evenly, but also dirt on the inner wall of the tank cannot be removed because spraying force is weak. Therefore, when the chemical fluid is injected into the tank, impurities remaining in the tank are mixed into the chemical solution, and the purity of the chemical solution deteriorates.

In addition, conventionally, there is also a method of filling a tank with cleaning fluid to clean the tank. For example, as illustrated in FIG. 1, cleaning fluid 6 is injected into a tank 7 standing upright up to almost its maximum capacity (more than 90%), the inner wall of the tank 7 and the cleaning fluid 6 are brought into contact with each other for a long time, impurities in the tank are further removed, and then the cleaning fluid 6 is removed.

However, in a conventional method of cleaning a tank, since it is necessary to inject the cleaning fluid 6 to almost the maximum capacity, it is necessary to use a large amount of the cleaning fluid 6 and to bring the inner wall of the tank 7 into contact with the cleaning fluid 6 for a long time, leading to a large increase in costs of cleaning work and a large increase in duration of cleaning, namely, deterioration in cost effectiveness of the cleaning work.

In addition, in the conventional method of cleaning a tank in which the inside of the tank is filled with the cleaning fluid, the cleaning fluid 6 is not injected up to the top space inside the tank 7 in consideration of safety. Thus, the top space inside the tank 7 cannot be cleaned. Therefore, after a chemical solution is injected into the tank 7, the impurities remaining in the top space inside the tank 7 are mixed into the chemical solution, leading to deterioration in purity of the chemical solution. Thus, the yield of semiconductor manufacturing is adversely affected.

The overcoming of various problems of the prior art described above is a problem to be solved.

### Solution to Problem

In view of the various disadvantages of the prior art described above,
a cleaning device according to the present invention is
a cleaning device configured to clean an inside of a cylindrical tank through rotation of a mounting member formed of a frame having a housing space, the mounting member fixing the tank in a state of being turned sideways in the housing space, the cleaning device including:
a first rotation jig mounted on a first side portion of the mounting member; and
a second rotation jig mounted on a second side portion of the mounting member,
in which the first rotation jig and the second rotation jig are configured to rotate the mounting member in cooperation with each other.

Further, in the cleaning device of the present invention,
the first rotation jig includes:
a first rotation body having an annular shape, the first rotation body being fixed to the first side portion of the mounting member and rotated in conjunction with the rotation of the mounting member; and
a first base configured to place the first rotation body thereon,
the first rotation body is configured to be rotatable relative to the first base,
the first base includes:
a first base body; and
a first functional member provided on the first base body, and
the first functional member slidably contacts a surface of the first rotation body in a circumferential direction of the first rotation body.

Further, in the cleaning device of the present invention,
the first functional member includes:
a first support frame provided in connection with the first base body; and
a plurality of first rollers rotatably provided on the first support frame, and
each of the plurality of first rollers contacts the surface of the first rotation body.

Further, in the cleaning device of the present invention,
the second rotation jig includes:
a second rotation body having an annular shape, the second rotation body being fixed to the second side portion of the mounting member and rotated in conjunction with the rotation of the mounting member; and
a second base configured to place the second rotation body thereon,
the second rotation body is configured to be rotatable relative to the second base,
the second base includes:
a second base body; and
a second functional member provided on the second base body, and
the second functional member slidably contacts a surface of the second rotation body in a circumferential direction of the second rotation body.

Further, in the cleaning device of the present invention,
the second functional member includes:
a second support frame provided in connection with the second base body; and
a plurality of second rollers rotatably provided on the second support frame, and
each of the plurality of second rollers contacts the surface of the second rotation body.

Further, the cleaning device of the present invention further includes
a pipe position restricting member provided on the first rotation jig, the pipe position restricting member restricting a positional fluctuation of a pipe connected to the tank.

Further, the cleaning device of the present invention further includes a ladder member provided on the second rotation jig,
in which the ladder member is configured to be foldable.

Further, in the cleaning device of the present invention,
the mounting member has a rectangular frame.

Further, in the cleaning device of the present invention,
the first rotation jig and/or the second rotation jig include an interval adjustment member configured to adjust an interval defined between the first rotation jig and the second rotation jig.

Further, in the cleaning device of the present invention,
the interval adjustment member is a first movement roller provided at a lower end of the first rotation jig and/or a second movement roller provided at a lower end of the second rotation jig.

Further, the cleaning device of the present invention includes
a pair of rails configured to place the first movement roller and/or the second movement roller thereon.

Further, a method of cleaning a tank of the present invention includes:
a step of preparing the cleaning device;
a step of fixing the tank turned sideways to the frame having the housing space of the mounting member;
a step of injecting cleaning fluid into the tank; and
a cleaning step of rotating the mounting member around an axial line of the tank by the first rotation jig and the second rotation jig, and cleaning the inside of the tank with the cleaning fluid.

Further, in the method of cleaning a tank of the present invention,
in the cleaning step, the tank is rotated over an entire circumference in an outer circumferential direction of the tank.

### Advantageous Effects of Invention

According to the cleaning device and the method of cleaning a tank of the present invention, mainly by the arrangement of the first rotation jig and the second rotation jig, the tank that is turned sideways and fixed to the frame of the mounting member is rotated in conjunction with the mounting member, whereby cleaning fluid in the tank is stirred, and impurities in the tank can be removed. Therefore, as compared with a conventional method of cleaning a tank standing upright, the cleaning device and the method of cleaning a tank of the present invention can efficiently clean the inside of the tank.

In addition, by performing rotation of the tank that is turned sideways and fixed to the frame of the mounting member, the nano-impurities remaining in the tank can be stirred and dissolved by the cleaning fluid. Therefore, as compared with the conventional method of cleaning a tank by spraying cleaning fluid, the cleaning device and the method of cleaning a tank according to the present invention can evenly clean the entire area inside the tank, and dirt on the inner wall of the tank can be easily removed by strong rotational force of the tank. As a result, when a chemical solution necessary for a semiconductor wafer process is stored in the tank, the purity of the chemical solution is kept high without allowing nano-impurities to be mixed into the chemical solution in the tank, and the yield of the semiconductor wafer process can be improved.

Furthermore, in the method of cleaning a tank according to the invention of the present invention, since cleaning work can be performed when there is cleaning fluid of half the capacity of the tank by rotation of the tank that is turned sideways and fixed to the frame of the mounting member, the use amount of the cleaning fluid can be significantly reduced, and the step of bringing the inner wall of the tank into contact with the cleaning fluid for a long time is not required. Therefore, the method of cleaning a tank according to the invention of the present invention can significantly reduce costs required for cleaning work and shorten the cleaning time, and can improve cost effectiveness of the cleaning work.

Further, in the method of cleaning a tank according to the invention of the present invention, cleaning work can be performed when there is cleaning fluid of half the capacity of the tank by rotation of the tank that is turned sideways and fixed to the frame of the mounting member, thereby making it possible to secure the safety of the cleaning work. Furthermore, since the entire region inside the tank can be cleaned, the nano-impurities do not remain in the entire region inside the tank after the cleaning work performed by the method of cleaning the tank according to the invention of the present invention, as compared with the conventional method of cleaning a tank in which the inside of the tank is filled with cleaning fluid. For this reason, when a chemical solution necessary for a semiconductor wafer process is stored in the tank, nano-impurities are not mixed into the chemical solution in the tank, and the purity of the chemical solution is kept high, thereby making it possible to improve the yield of the semiconductor wafer process.

### BRIEF DESCRIPTION OF THE DRAWINGS

FIG. 1 is a transparent view illustrating a conventional method of cleaning a tank.

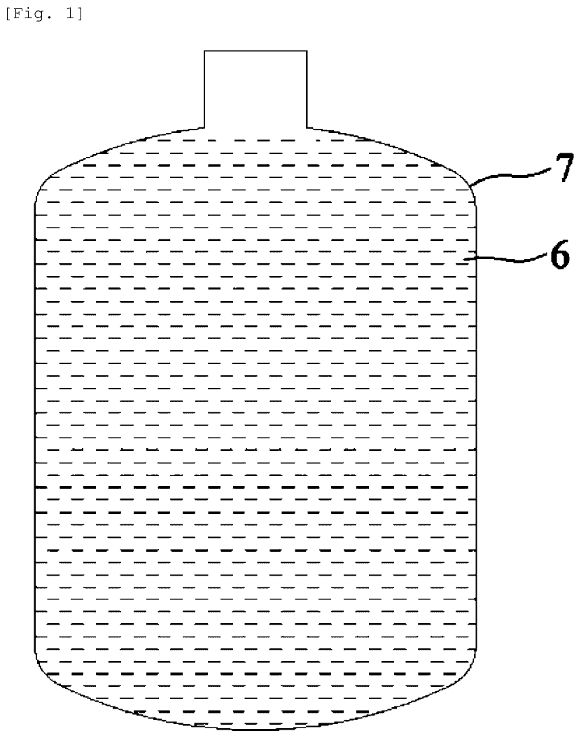

FIG. 2 is a perspective view illustrating a first embodiment of a cleaning device according to the present invention, a mounting member, and a tank.

FIG. 3 is a perspective view of FIG. 2 as viewed from another viewpoint.

FIG. 4 is a perspective view illustrating a state before the tank is fixed to the mounting member.

FIG. 5 is a perspective view illustrating a state in which the tank is fixed to the mounting member.

FIG. 6 is a perspective view of a first rotation jig of the cleaning device according to the present invention.

FIG. 7 is a local perspective view of the first rotation jig illustrated in FIG. 6.

FIG. 8 is a perspective view of a second rotation jig of the cleaning device according to the present invention.

FIG. 9 is a local perspective view of the second rotation jig illustrated in FIG. 8.

FIG. 10 is a schematic view illustrating a state in which cleaning fluid is injected into the tank.

FIG. 11 is a schematic view illustrating another state in which the cleaning fluid is injected into the tank.

FIG. 12 is a side view illustrating a second embodiment of the cleaning device according to the present invention.

### DESCRIPTION OF THE INVENTION

Hereinafter, the present invention will be described based on specific embodiments. Those skilled in the art will easily understand other advantages and effects of the present invention from the contents disclosed in the present specification.

In addition, such as the structures, proportions, and sizes illustrated in the drawings of the present specification are adapted to the disclosure of the specification in order to facilitate understanding and browsing, and are not conditions for limiting the implementation of the present invention. It should be understood that any modifications in structure, changes in proportional relationship, or adjustments in size are to be included in the scope of the disclosure of the present invention as long as the effect that the present invention can exert and the object that can be achieved are not affected. In addition, the terms such as “on”, “first”, “second”, and “position” described in the present specification are given for easy understanding and viewing and thus do not limit the scope of the invention of the present invention. It should be understood that changes and adjustments thereof are included in the scope of the invention of the present invention unless there is a substantial change in the technical content.

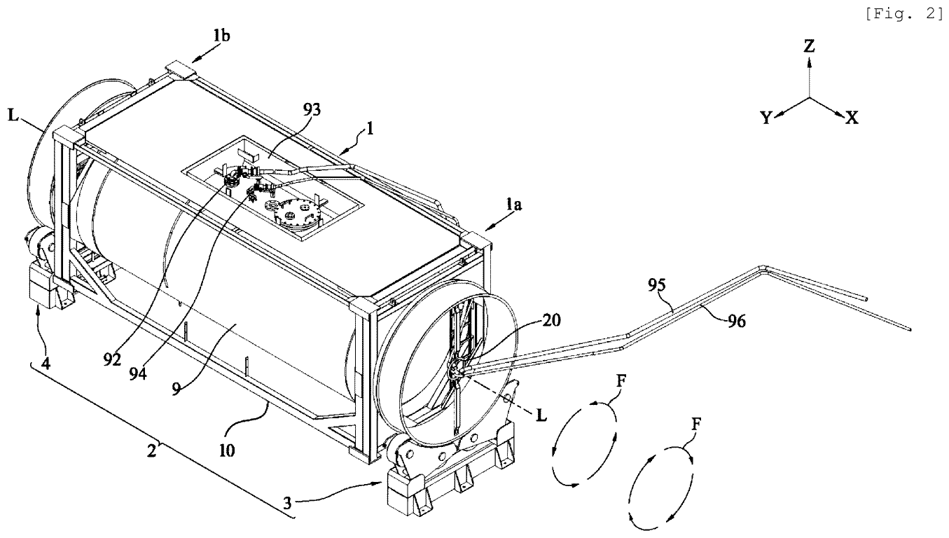

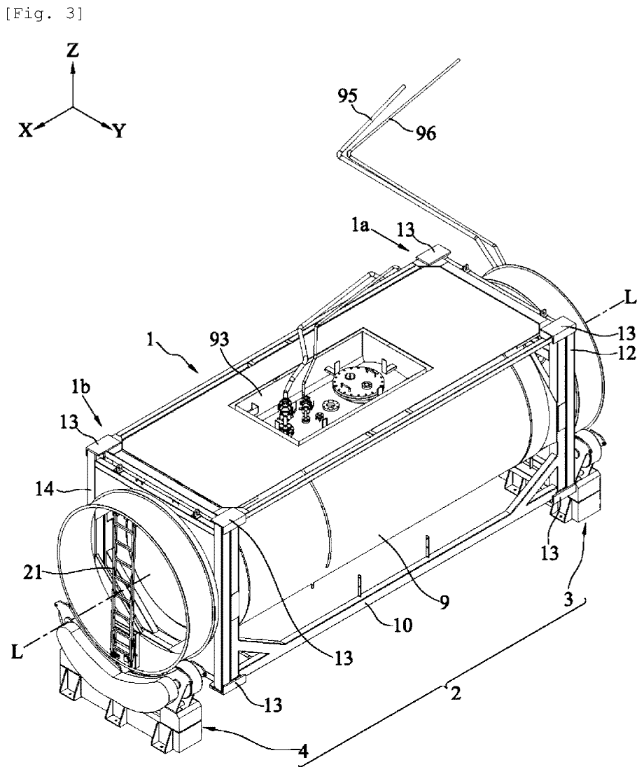

FIGS. 2 to 11 are views each illustrating a cleaning device 2, which is a first embodiment of a cleaning device according to the present invention. As illustrated in FIGS. 2 and 3, in the cleaning device 2, a cylindrical tank 9 is fixed, and a mounting member 1 including a frame 10 is rotated to clean the inside of the tank 9.

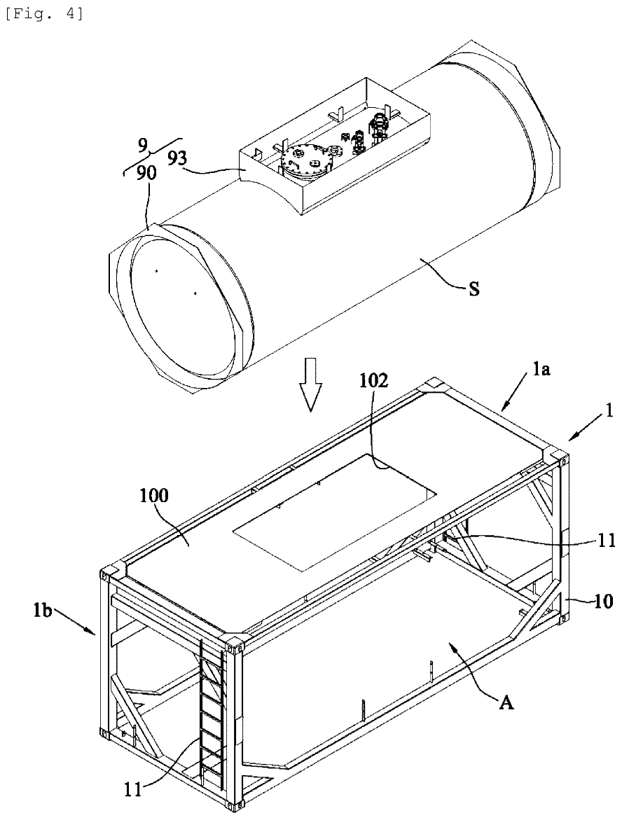

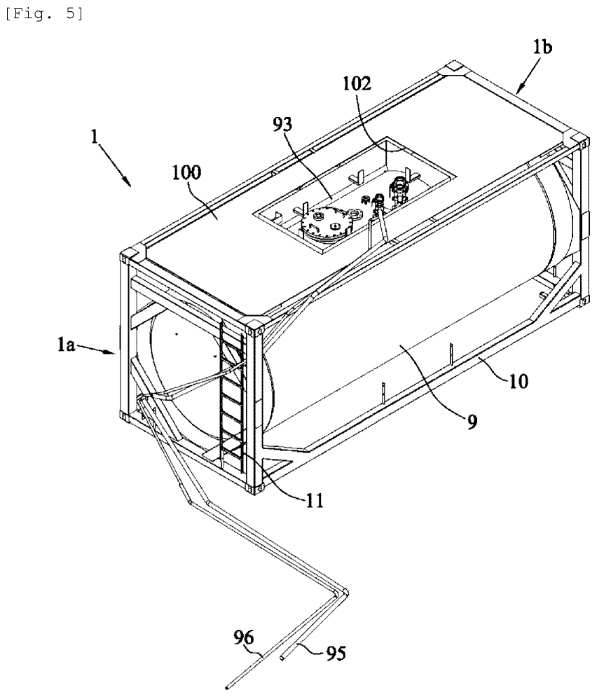

As illustrated in FIGS. 4 and 5, the mounting member 1 has a first side portion 1a and a second side portion 1b facing each other. The frame 10 of the mounting member 1 has a rectangular shape, and has a housing space A for fixing the tank 9 in the lateral direction. The mounting member 1 further includes ladder structures 11 respectively provided on the first side portion 1a and the second side portion 1b. The frame 10 includes an upper cover 100. For example, when the tank 9 is placed on the frame 10, the upper cover 100 is first removed from the frame 10, the tank 9 is housed in the housing space A from above the frame 10, and then the upper cover 100 is attached to the frame 10 again.

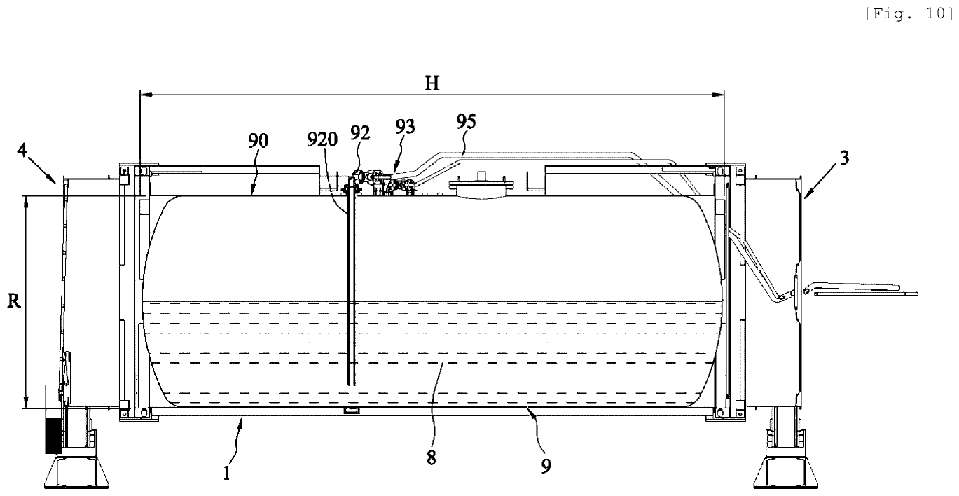

The tank 9 is a chemical storage tank and includes a tank body 90 having a substantially cylindrical shape and an accessory box 93 provided on an outer circumferential face S of the tank body 90. The standard of the tank 9 illustrated in FIG. 10 is a metallic container structure having a diameter R slightly smaller than 2500 mm and a total height H of 6160 mm, resulting in a gross weight of approximately 5 tons. Note that the upper cover 100 has an opening 102 that exposes and houses the accessory box 93. Here, it should be noted that various standards can be applied to the tank 9, and the tank 9 is not limited to the above standards.

The cleaning device 2 includes a first rotation jig 3 and a second rotation jig 4. As illustrated in FIGS. 2 and 3, the first rotation jig 3 is mounted on the first side portion 1a of the mounting member 1, the second rotation jig 4 is mounted on the second side portion 1b of the mounting member 1, and the first rotation jig 3 and the second rotation jig 4 are configured to rotate the mounting member 1 in cooperation with each other.

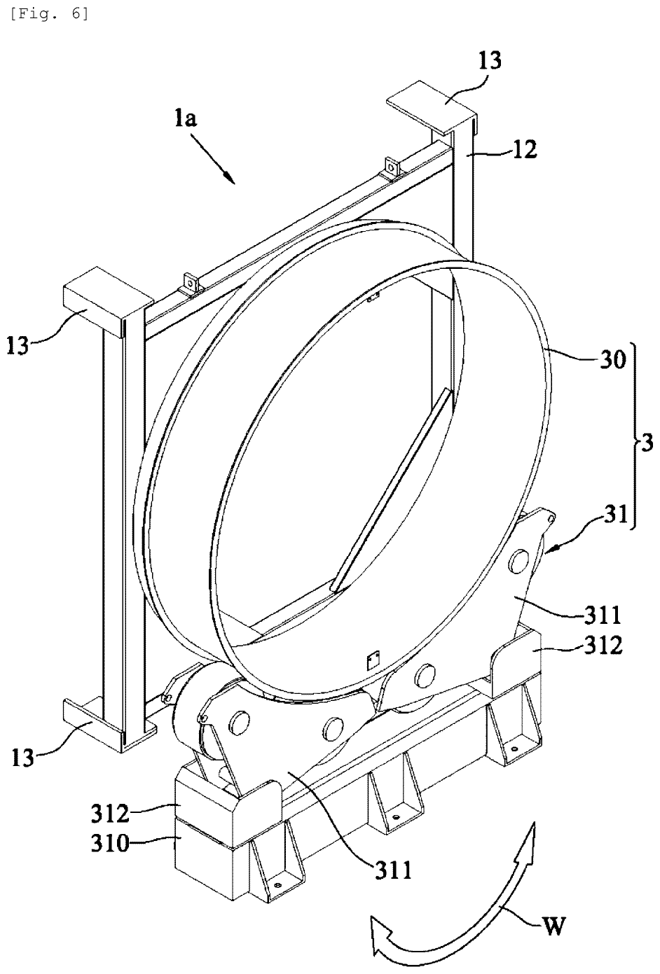

The first rotation jig 3 includes an annular first rotation body 30 and a first base 31 on which the first rotation body 30 is placed. As illustrated in FIG. 6, the first rotation body 30 is configured to be fixed to the first side portion 1a of the mounting member 1, to be rotated in conjunction with rotation of the mounting member 1, and to be rotated relative to the first base 31.

In the present embodiment, a relay frame 12 is further provided on the side of the first rotation jig 3 fixed to the first side portion 1a of the mounting member 1. The relay frame 12 is fixed to the first rotation body 30. When the first rotation jig 3 is mounted on the first side portion 1a of the mounting member 1, the frame 10 of the mounting member 1 and the relay frame 12 are connected to each other by a plurality of brackets 13.

The first base 31 is a turning roller and includes a first base body 310 and a first functional member 311 provided on the first base body 310. The first functional member 311 slidably abuts on the surface of the first rotation body 30 in the circumferential direction W of the first rotation body 30.

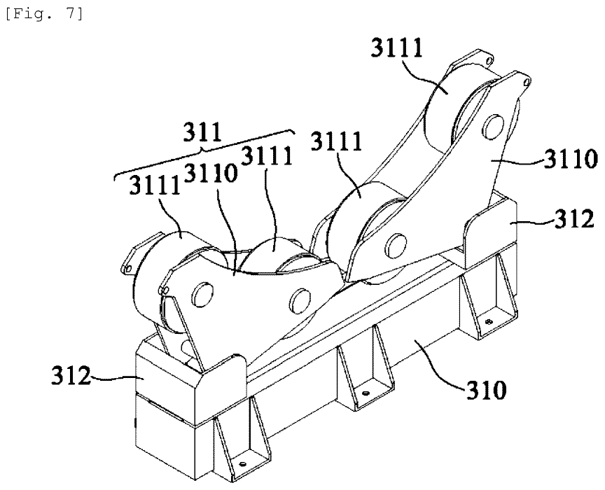

In the present embodiment, the first functional member 311 includes a first support frame 3110 provided in connection with the first base body 310, and a first roller 3111 rotatably provided on the first support frame 3110. As illustrated in FIG. 7, the plurality of first rollers 3111 are in contact with the surface (that is, the outer circumferential face of the first rotation body 30) of the first rotation body 30.

The first support frame 3110 is fixed to the first base body 310, and a rotation shaft of the first roller 3111 is connected to the first support frame 3110. For example, two first rollers 3111 are disposed on one first support frame 3110.

Preferably, the first support frame 3110 may be fixed to the first base body 310 via a first adjustment member 312. The first adjustment member 312 has a step structure (not illustrated). Since the first support frame 3110 is fixed to one of the plurality of steps included in the step structure, the height position of the first support frame 3110 can be changed as necessary to adjust the position of the first roller 3111 relative to the outer circumferential face of the first rotation body 30. As a result, it is possible to perform adjustment so as to arrange the first functional member 311 at an appropriate position on the outer circumferential face of the first rotation body 30. In addition, various members can be used as the first adjustment member 312, and it is needless to say that the first adjustment member 312 is not limited to the above description.

In addition, the first functional members 311 are symmetrically disposed relative to a center of the first base body 310 in a direction (a direction of an axis X in an XYZ coordinate system illustrated in FIG. 2) orthogonal to the longitudinal direction of the first base body 310 as a boundary therebetween, thereby enabling the first roller 3111 to stably rotate the first rotation body 30 and the mounting member 1.

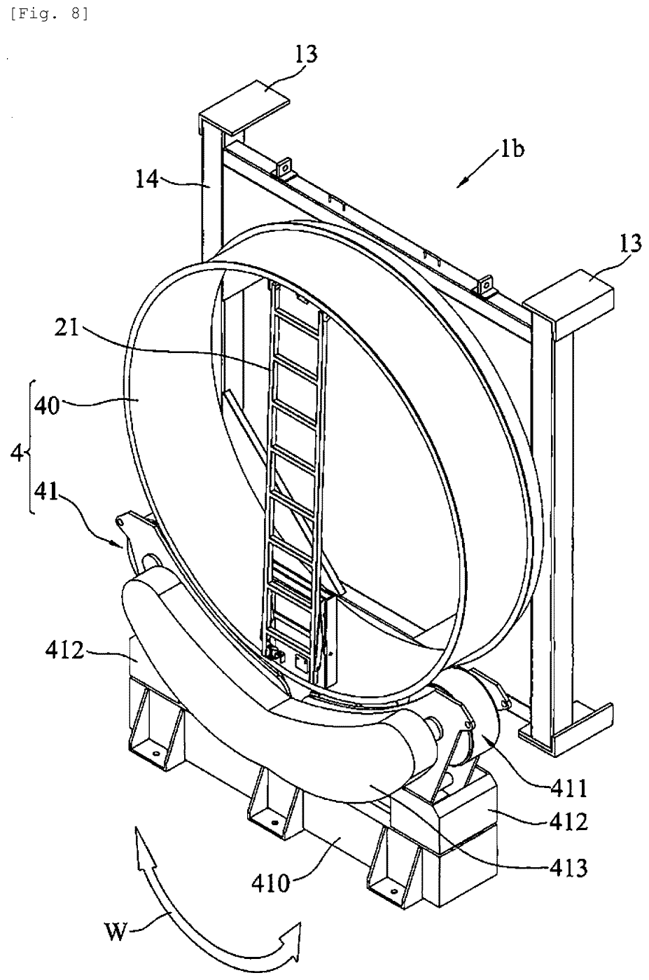

The second rotation jig 4 includes an annular second rotation body 40 and a second base 41 on which the second rotation body 40 is placed. As illustrated in FIG. 8, the second rotation body 40 is configured to be fixed to the second side portion 1b of the mounting member 1, to be rotated in conjunction with rotation of the mounting member 1, and to be rotated relative to the second base 41.

In the present embodiment, a relay frame 14 is further provided on the side of the second rotation jig 4 fixed to the second side portion 1b of the mounting member 1. The relay frame 14 is fixed to the second rotation body 40. When the second rotation jig 4 is mounted on the second side portion 1b of the mounting member 1, the frame 10 of the mounting member 1 and the relay frame 14 are connected to each other by a plurality of brackets 13.

The second base 41 includes a second base body 410 and a second functional member 411 provided on the second base body 410. The second functional member 411 slidably abuts on the surface of the second rotation body 40 in the circumferential direction W of the second rotation body 40.

In the present embodiment, as illustrated in FIGS. 2 and 3, the first base 31 and the second base 41 are arranged in an axial direction (the axial direction is also a direction of an axial line L of the tank 9 and a direction of the axis X in the XYZ coordinate system illustrated in FIGS. 2 and 3) of the tank 9.

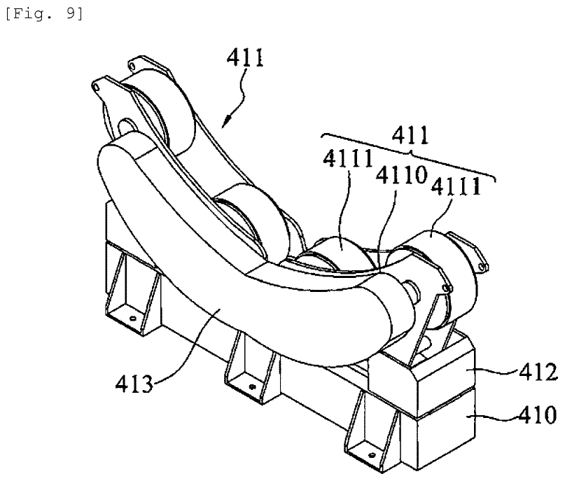

As illustrated in FIG. 9, the second functional member 411 includes a second support frame 4110 provided in connection with the second base body 410, and a second roller 4111 rotatably provided on the second support frame 4110. The plurality of second rollers 4111 are in contact with the surface (that is, the outer circumferential face of the second rotation body 40) of the second rotation body 40.

The second support frame 4110 is fixed to the second base body 410, and a rotation shaft of the second roller 4111 is connected to the second support frame 4110. For example, two second rollers 4111 are disposed on one second support frame 4110. Preferably, the strength of the entire structure of the second functional member 411 may be enhanced by fixing the two second support frames 4110 by an auxiliary frame 413. Further, the second support frame 4110 may be fixed to the second base body 410 via a second adjustment member 412.

Preferably, the second adjustment member 412 has a step structure (not illustrated). Since the second support frame 4110 is fixed to one of the plurality of steps included in the step structure, the height position of the second support frame 4110 can be changed as necessary to adjust the position of the second roller 4111 relative to the outer circumferential face of the second rotation body 40. As a result, it is possible to perform adjustment so as to arrange the second functional member 411 at an appropriate position on the outer circumferential face of the second rotation body 40. In addition, various members can be used as the second adjustment member 412, and it is needless to say that the second adjustment member 412 is not limited to the above description.

In addition, the second functional members 411 are symmetrically disposed relative to a center of the second base body 410 in a direction orthogonal to the longitudinal direction of the second base body 410 (a direction of the axis X) as a boundary therebetween, thereby enabling the second roller 4111 to stably rotate the second rotation body 40 and the mounting member 1.

As illustrated in FIG. 2, the cleaning device 2 further includes a pipe position restricting member 20 provided on the first rotation jig 3 and configured to restrict a positional fluctuation of a pipe connected to the tank 9.

In the present embodiment, the pipe position restricting member 20 has an annular structure that allows a plurality of pipes 95 to pass therethrough in a concentrated manner. The plurality of pipes 95 are disposed across the first rotation jig 3 and the tank 9 via the pipe position restricting member 20.

As illustrated in FIG. 3, the cleaning device 2 further includes a ladder member 21 provided on the second rotation jig 4. Further, the ladder member 21 may be a foldable ladder.

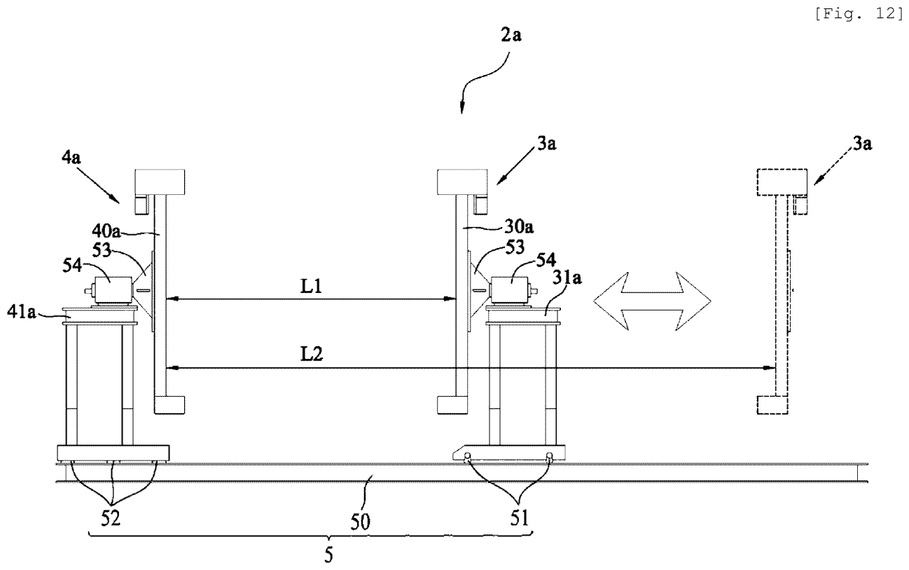

Next, a cleaning device 2a, which is a second embodiment of the cleaning device according to the present invention, will be described with reference to FIG. 12. As illustrated in FIG. 12, the cleaning device 2a is provided with an interval adjustment member 5 that adjusts an interval between a first rotation jig 3a and a second rotation jig 4a.

The interval adjustment member 5 includes a first movement roller 51 provided at the lower end of the first rotation jig 3a and a fixation base 52 provided at the lower end of the second rotation jig 4a. The interval adjustment member 5 further includes a pair of rails 50 on which the first movement roller 51 is placed such that the first rotation jig 3a can move forwards and rearwards.

The first rotation jig 3a is movable to a desired position along the rails 50. As a result, a distance between the first rotation jig 3a and the second rotation jig 4a can be set to be, for example, a small distance L1 of 3100 mm (about 10 feet) or a large distance L2 of 6160 mm (about 20 feet) as necessary.

Further, in the present embodiment, the first rotation jig 3a is on the position adjustment side, and the second rotation jig 4a is on the fixed side. However, as another embodiment, the second rotation jig 4a may be on the position adjustment side, a second movement roller (not illustrated) may be disposed at the lower end thereof, and the first rotation jig 3a may be on the fixed side, and the fixation base (not illustrated) may be disposed at the lower end thereof. As still another embodiment, the first movement roller 51 may be disposed at the lower end of the first rotation jig 3a, the second movement roller (not illustrated) may be disposed at the lower end of the second rotation jig 4a, and both the first rotation jig 3a and the second rotation jig 4a may be disposed on the position adjustment side.

Further, the position adjustment of the rotation jig on the position adjustment side may be performed by switching different methods. For example, the first rotation jig 3a and/or the second rotation jig 4a may be moved automatically or manually as necessary.

The structure of the first rotation jig 3a (a first rotation body 30a and a first base 31a) of the second embodiment is different from the structure of the first rotation jig 3 (the first rotation body 30 and the first base 31) of the first embodiment, and the structure of the second rotation jig 4a (a second rotation body 40a and a second base 41a) of the second embodiment is different from the structure of the second rotation jig 4 (the second rotation body 40 and the second base 41) of the first embodiment. For example, a shaft frame 53 is disposed in the annular frame of the first rotation body 30a of the second embodiment, and the first base 31a of the second embodiment is connected to the shaft frame 53 via a motor 54, thereby rotating the first rotation body 30a. For example, the shaft frame 53 is disposed in the annular frame of the second rotation body 40a of the second embodiment, and the second base 41a of the second embodiment is connected to the shaft frame 53 via the motor 54, thereby rotating the second rotation body 40a.

It goes without saying that the interval adjustment member may be disposed on the first rotation jig 3 and/or the second rotation jig 4 of the first embodiment.

When the cleaning devices 2 and 2a according to the present invention are used, after the tank 9 is horizontally placed and housed in the housing space A of the frame 10, the first rotation jigs 3 and 3a and the second rotation jigs 4 and 4a of the cleaning devices 2 and 2a are mounted on the mounting member 1, and the mounting member 1 is rotated by rotating the first rotation jigs 3 and 3a and the second rotation jigs 4 and 4a by external force. Therefore, the cleaning devices 2 and 2a according to the present invention can be suitably used for cleaning work of the tank 9.

In addition, the mounting member 1 is rotated as necessary. For example, the mounting member 1 (the tank 9 housed in the housing space A of the frame 10) may be rotated so as to have a specified value as indicated in the following Table 1.

TABLE 1

| Item | Specified value |
|---|---|
| Number of rotations | 0.1 rpm to 0.3 rpm |
| Angle | 0° to 360° |
| Number of times of reciprocation | 5 times to 20 times |

Hereinafter, specific steps of a method of cleaning the tank 9 according to the present invention used for cleaning work of the tank 9 will be described with reference to FIGS. 2 to 12.

The method of cleaning the tank 9 using the cleaning device 2 according to the first embodiment of the present invention will be described. Note that an installation surface (for example, an environmental surface such as the ground) of the first base 31 of the first rotation jig 3 is defined as a reference surface, a lateral direction of the tank 9 is defined as a forward-and-rearward direction (that is, the axial direction of the tank 9, for example, a direction of the axis X in the XYZ coordinate system illustrated in FIG. 2), another coordinate axis on the reference surface is defined as a left-and-right direction (for example, a direction of the axis Y in the XYZ coordinate system illustrated in FIG. 2), and an upright direction of the tank 9 before the tank is turned sideways is defined as a vertical direction (for example, a direction of the axis Z in the XYZ coordinate system illustrated in FIG. 2).

First, the tank 9 turned sideways is fixed to the housing space A of the frame 10 of the mounting member 1.

Next, the cleaning fluid 8 is injected into the tank body 90 of the tank 9. Here, as illustrated in FIG. 10, the cleaning fluid 8 may be injected not to reach the maximum capacity of the tank body 90 of the tank 9 but to reach approximately half of the maximum capacity. For example, an inlet port 92 is provided on the accessory box 93, and an inlet tube 920 inserted into the tank body 90 and a pipe 95 for transporting the cleaning fluid 8 from a supply source (not illustrated) of the cleaning fluid 8 are connected to the inlet port 92, whereby the cleaning fluid 8 is injected into the tank body 90.

In the present embodiment, the cleaning fluid 8 contains hydrogen peroxide accounting for 31%, and the density of the cleaning fluid 8 is 1.11 g/cm³. The cleaning fluid 8 is, at its maximum, half the maximum capacity of the tank body 90 (approximately 20 tons in weight). Thus, when the first roller 3111 and the second roller 4111 are rotated, the cleaning fluid 8 in the tank body 90 is stirred.

Note that, as another process, before the tank 9 is leaned, first, the cleaning fluid 8 may be injected into the tank body 90, and then the tank 9 may be leaned sideways to fix the tank 9 containing the cleaning fluid 8 to the housing space A of the frame 10.

Next, the first rotation jig 3 is attached to the first side portion 1a of the mounting member 1, and the second rotation jig 4 is attached to the second side portion 1b of the mounting member 1. By rotating the first rotation jig 3 and the second rotation jig 4 by external force, the tank 9 into which the cleaning fluid 8 is injected rotates around the axial line L of the tank 9 along with the mounting member 1. As a result, the cleaning fluid 8 in the tank body 90 is stirred, and the inside of the tank 9 is cleaned with the stirred cleaning fluid 8.

In the present embodiment, the first rotation jig 3 and the second rotation jig 4 are rotated by external forces such as human power or device. For example, the first rotation jig 3 and the second rotation jig 4 are rotated by rotating the first roller 3111 and the second roller 4111 by a motor.

In addition, since the pipe position restricting member 20 is provided at the center of the circle of the first rotation body 30 and restricts a positional fluctuation of the pipe 95 connected to the tank 9, it is possible to prevent the pipe 95 from being entangled with the first rotation body 30. The rotation of the tank 9 may be counterclockwise rotation or clockwise rotation as in the rotation direction F illustrated in FIG. 2. Furthermore, for example, the tank 9 can reciprocate so as to rotate one round in the clockwise direction after rotating one round (360°) in the counterclockwise direction, or to rotate one round in the counterclockwise direction after rotating one round in the clockwise direction. That is, in the cleaning step, the tank 9 rotates in a reciprocating manner in both the clockwise direction and the counterclockwise direction.

After cleaning work is completed, the cleaning fluid 8 is extracted from the tank body 90 through the inlet port 92 of the tank 9 by the inlet tube 920, and the cleaning fluid 8 is transported to a predetermined position outside the tank 9, such as a waste fluid collection site (not illustrated), for example.

A cleaning method using the cleaning device 2a according to the second embodiment of the invention of the present invention is also the same as described above.

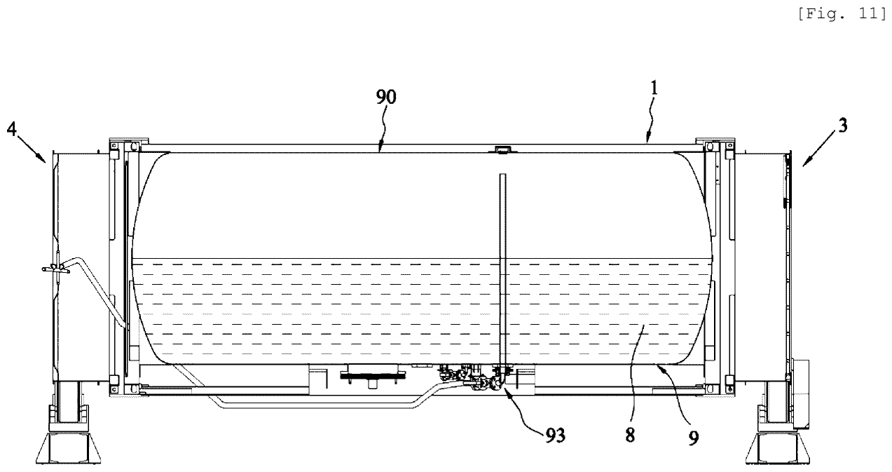

Thus, in the cleaning devices 2 and 2a and the method of cleaning the tank 9 of the present invention, the first rotation jigs 3 and 3a and the second rotation jigs 4 and 4a are mainly configured to rotate the mounting member 1 in cooperation with each other, so that the tank 9 turned sideways and fixed to the frame 10 can be cleaned, and the cleaning device and the method of cleaning the tank 9 of the present invention have the following advantages as compared with the conventional method of cleaning a tank standing upright.
(1) In the method of cleaning the tank 9 turned sideways by the cleaning devices 2 and 2a of the present invention, since the mounting member 1 (the tank 9 housed in the housing space A of the frame 10) can be rotated 360°, the use amount of chemical solution can be reduced, and each portion inside the tank 9 can be easily cleaned as compared with a conventional method of cleaning a non-rotatable tank standing upright.
(2) Since the pipe position restricting member 20 restricts the position at which the pipe 95 passes through the first rotation jig 3 to the rotation center, it is not necessary to remove the pipe 95 when the tank 9 is rotated, and there is no risk that foreign substances enter the pipe 95 and the cleaning fluid 8 is contaminated, thereby making it possible to improve efficiency in cleaning work and cleanliness of cleaning work. In addition, as illustrated in FIG. 2, the position of a cable 96 (also refer to an inspection port 94 illustrated in FIG. 2) of a detection device that detects the internal cleanness of the tank body 90, which passes through the first rotation jig 3, is also restricted to the rotation center by the pipe position restricting member 20. Therefore, when the tank 9 is rotated, cleaning work and detection work can proceed simultaneously, and the cleanness of the inside of the tank body 90 can be confirmed in real time.
(3) In the invention of the present invention, since a ladder function is provided, that is, the second rotation jig 4 is provided with the ladder member 21, a worker can easily climb up and down the tank 9 to perform cleaning related work, and it is not necessary to use unstable stairs. Therefore, it is possible not only to secure the safety of work of a worker, but also to improve work efficiency.
(4) In the invention of the present invention, since the tank 9 can be rotated around the entire circumference, not only the inside of the tank 9 can be washed away with the cleaning fluid 8 in the cleaning step, but also the tank 9 can be rotated to move the position of the accessory box 93 from the upper side to the lower side, and, by using the cleaning fluid 8, the periphery of the accessory box 93 of the tank 9 that is dirty can be filled with the cleaning fluid 8 as it is as illustrated in FIG. 11, thereby making it possible to clean the opposite side of the bottom portion side of the tank 9. Therefore, it is possible to ensure more complete cleaning in the tank 9.
(5) Since distances L1 and L2 between the first rotation jig 3a and the second rotation jig 4a can be adjusted by the interval adjustment member 5 in accordance with a height H of each of the different tanks 9, the tanks 9 having different sizes can be cleaned at the same point, and it is not necessary to convey the cleaning device 2a to the installation position of each tank 9.

In addition, the mounting member 1 according to the invention of the present invention is configured with the frame 10 and disperses stress applied to the outer circumferential face S during rotation of the tank 9, thereby making it possible to effectively overcome the problem of deformation occurring when the tank 9 is cleaned.

As described above, in the present invention, the cleaning fluid 8 can be stirred to remove impurities in the tank 9 by rotation of the tank 9 turned sideways. Therefore, as compared with a conventional method of cleaning a tank by spraying cleaning fluid, the entire region inside the tank body 90 of the tank 9 can be effectively and uniformly cleaned by the rotation angle (up to 360° is possible) of the tank 9 of the cleaning devices 2 and 2a and the method of cleaning the tank 9 of the present invention. In addition, rotational force of the tank 9 is strong, and the cleaning fluid 8 in the tank is strongly stirred, whereby dirt on the inner wall surface of the tank body 90 of the tank 9 can be easily removed. As described above, when the chemical solution necessary for a semiconductor process is injected into the tank body 90 of the tank 9, various impurities are not mixed into the chemical solution in the tank body 90 of the tank 9 and, as such, the purity of the chemical solution is kept high and the yield of the semiconductor process can be secured.

In addition, as compared with a conventional method of cleaning a tank in which the inside of the tank is filled with cleaning fluid, in the method of cleaning a tank according to the present invention, when the cleaning fluid 8 of half the maximum capacity is injected into the tank body 90 of the tank 9 by rotation of the tank 9 turned sideways, cleaning work becomes possible. Therefore, the use amount of the cleaning fluid 8 can be significantly reduced, and a step of bringing the inner wall of the tank into contact with the cleaning fluid for a long time is not required. Therefore, the method of cleaning a tank according to the invention of the present invention can reduce costs of cleaning work and shorten the cleaning time, thereby improving cost effectiveness of cleaning work.

In addition, as compared with the conventional method of cleaning a tank in which the inside of the tank is filled with cleaning fluid, in the method of cleaning a tank of the present invention, cleaning work becomes possible when the cleaning fluid 8 of half the maximum capacity is injected into the tank body 90 of the tank 9 by rotation of the tank 9 turned sideways, thereby making it possible not only to improve the safety of cleaning work, but also to clean the entire region inside the tank body 90 of the tank 9. Therefore, when cleaning work is performed by the cleaning device and the method of cleaning the tank 9 according to the present invention, impurities do not remain in the entire region inside the tank body 90 of the tank 9. Therefore, when the chemical solution necessary for a semiconductor process is injected into the tank body 90 of the tank 9, various impurities are not mixed into the chemical solution in the tank body 90 of the tank 9 and, as such, the purity of the chemical solution is kept high and the yield of the semiconductor process can be secured.

Further, according to the cleaning devices 2 and 2a of the present invention, since two rotation jigs (first rotation jigs 3 and 3a, second rotation jigs 4 and 4a) are mainly installed to hold the mounting member 1 in a symmetrical manner, the tank 9 can have sufficient deformation resistance at the time of horizontal placement and rotation thereof, thereby effectively dispersing stress (for example, rotational centrifugal force) applied to the outer circumferential face S of the tank 9 into which the cleaning fluid 8 is injected, and preventing occurrence of a problem of stress concentration. In addition, the mounting member 1 and the tank 9 into which the cleaning fluid 8 is injected can be stably supported by the first rotation jig 3 and the second rotation jig 4, and the tank 9 (regardless of whether the cleaning fluid 8 is injected into the tank) is not deformed.

As described above, the cleaning device and the method of cleaning the tank 9 of the present invention are advantageous for development of a semiconductor process because the first rotation jig and the second rotation jig can be installed to realize cleaning work that enables a high cleaning effect, a cleaning time can be shortened, and for example, the start-up time of the semiconductor process (preparation time of a production line) can be shortened.

In addition, in the cleaning step by rotation of a tank turned sideways of the present invention, significant rotation can be performed, and the need for a clean level of a process with high precision such as a semiconductor process can be satisfied.

The above embodiments are merely for describing the principle and effects of the present invention, and do not limit the present invention. Those skilled in the art can change the above embodiments without departing from the spirit and scope of the present invention. That is, the scope of the invention of the present invention to be protected is described in the claims.

### REFERENCE SIGNS LIST

1 Mounting member
1a First side portion
1b Second side portion
2 Cleaning device
2a Cleaning device
3 First rotation jig
3a First rotation jig
4 Second rotation jig
4a Second rotation jig
5 Interval adjustment member
6 Cleaning fluid
7 Tank
8 Cleaning fluid
9 Tank
10 Frame
11 Ladder structure
12 Relay frame
13 Bracket
14 Relay frame
20 Pipe position restricting member
21 Ladder member
30 First rotation body
30a First rotation body
31 First base
31a First base
40 Second rotation body
40a Second rotation body
41 Second base
41a Second base
50 Rail
51 First movement roller
52 Fixation base
53 Shaft frame
54 Motor
90 Tank body
92 Inlet port
93 Accessory box
94 Inspection port
95 Pipe
96 Cable
100 Upper cover
102 Opening
310 First base body
311 First functional member
312 First adjustment member
410 Second base body
411 Second functional member
412 Second adjustment member
413 Auxiliary frame
920 Inlet tube
3110 First support frame
3111 First roller
4110 Second support frame
4111 Second roller
A Housing space
F Rotation direction
H Height
L Axial line
L1 Distance
L2 Distance
R Diameter
S Outer circumferential face
W Circumferential direction

1. A cleaning device configured to clean an inside of a cylindrical tank through rotation of a mounting member formed of a frame having a housing space, the mounting member fixing the tank in a state of being turned sideways in the housing space, the cleaning device comprising:
a first rotation jig mounted on a first side portion of the mounting member; and
a second rotation jig mounted on a second side portion of the mounting member,
wherein the first rotation jig and the second rotation jig are configured to rotate the mounting member in cooperation with each other.

2. The cleaning device according to claim 1, wherein
the first rotation jig comprises:
a first rotation body having an annular shape, the first rotation body being fixed to the first side portion of the mounting member and rotated in conjunction with the rotation of the mounting member; and
a first base configured to place the first rotation body thereon,
the first rotation body is configured to be rotatable relative to the first base,
the first base comprises:
a first base body; and a first functional member provided on the first base body, and
the first functional member slidably contacts a surface of the first rotation body in a circumferential direction of the first rotation body.

3. The cleaning device according to claim 2, wherein
the first functional member comprises:
a first support frame provided in connection with the first base body; and
a plurality of first rollers rotatably provided on the first support frame, and
each of the plurality of first rollers contacts the surface of the first rotation body.

4. The cleaning device according to claim 1, wherein
the second rotation jig comprises:
a second rotation body having an annular shape, the second rotation body being fixed to the second side portion of the mounting member and rotated in conjunction with the rotation of the mounting member; and
a second base configured to place the second rotation body thereon,
the second rotation body is configured to be rotatable relative to the second base,
the second base comprises: a second base body; and
a second functional member provided on the second base body, and
the second functional member slidably contacts a surface of the second rotation body in a circumferential direction of the second rotation body.

5. The cleaning device according to claim 4, wherein
the second functional member comprises:
a second support frame provided in connection with the second base body; and
a plurality of second rollers rotatably provided on the second support frame, and each of the plurality of second rollers contacts the surface of the second rotation body.

6. The cleaning device according to claim 1, further comprising
a pipe position restricting member provided on the first rotation jig, the pipe position restricting member restricting a positional fluctuation of a pipe connected to the tank.

7. The cleaning device according to claim 1, further comprising a ladder member provided on the second rotation jig,
wherein the ladder member is configured to be foldable.

8. The cleaning device according to claim 1, wherein the mounting member has a rectangular frame.

9. The cleaning device according to claim 1, wherein the first rotation jig and/or the second rotation jig comprise an interval adjustment member configured to adjust an interval defined between the first rotation jig and the second rotation jig.

10. The cleaning device according to claim 9, wherein the interval adjustment member is a first movement roller provided at a lower end of the first rotation jig and/or a second movement roller provided at a lower end of the second rotation jig.

11. The cleaning device according to claim 10, comprising a pair of rails configured to place the first movement roller and/or the second movement roller thereon.

12. A method of cleaning a tank, comprising:
a step of preparing the cleaning device according to claim 1;
a step of fixing the tank turned sideways to the frame having the housing space of the mounting member;
a step of injecting cleaning fluid into the tank; and
a cleaning step of rotating the mounting member around an axial line of the tank by the first rotation jig and the second rotation jig, and cleaning the inside of the tank with the cleaning fluid.

13. The method of cleaning a tank according to claim 12, wherein, in the cleaning step, the tank is rotated over an entire circumference in an outer circumferential direction of the tank.
